(19) United States
(12) Patent Application Publication
(10) Pub. No.: US 2013/0342314 A1
(43) Pub. Date: Dec. 26, 2013

(54) SMART LOCK STRUCTURE AND OPERATING METHOD THEREOF

(71) Applicants: Gun Chen, Taipei City (TW); Shu-Shian Lin, Taipei City (TW)

(72) Inventors: Gun Chen, Taipei City (TW); Shu-Shian Lin, Taipei City (TW)

(21) Appl. No.: 13/531,478

(22) Filed: Jun. 22, 2012

(51) Int. Cl. G06F 7/04

(52) U.S. Cl. 340/5.65

(57) ABSTRACT

The present invention relates to a smart lock structure and an operating method thereof. The smart lock structure comprises a key hole for access keys, an interrogating device for using radio frequency technology to communicate with a mobile device and accept access requests from the mobile device to unlock the smart key structure, and a lock mechanism in response to interaction between the key hole and the access keys and communication between the interrogating device and the mobile device for unlocking the smart lock structure and gaining access thereof. The smart lock structure further comprises a falling proof device equipped beside the interrogating device to prevent falling of the mobile device. An operating method is also provided for normal operation and/or configuration of the smart lock structure.

### BACKGROUND OF THE INVENTION

1. Field of the Invention

The present invention relates to a smart lock structure and an operating method thereof, and more particularly to a smart lock structure having high security and safety and an operating method to configure and process unlocking function thereof through radio frequency technology according to effective security check and authentication.

2. The Related Art

RFID technology is widely adopted as identification to access certain secured property nowadays. However, such technology is not preferable to be used in highly security places due to its vulnerability to intentional security breach. Furthermore, for most of highly secured assets or areas, the cost and accompanied workload are always tremendous to make or maintain these specially authorized keys, access cards or other authenticable devices for authorized users. Moreover, additionally carrying of these keys, cards, or device all the time significantly makes the authorized users inconvenient. Therefore, it is desirable to have a lock interacting with a handy mobile phone with Near Field Communication technology embedded to overcome the security issue and inconvenience.

### BRIEF DESCRIPTION OF THE DRAWINGS

The present invention will be apparent to those skilled in the art by reading the following description thereof, with reference to the attached drawings, in which:

FIGS. 1A, 1B and 1C are schematic plan views of a smart lock structure in accordance with embodiments of the present invention;

FIGS. 2A and 2B are schematic perspective views of the smart lock structure in accordance with other embodiments of the present invention;

FIG. 3 is schematic plan view of the smart lock structure in accordance with other embodiments of the present invention showing various shapes of a falling proof device thereof from at least front viewing and right-side viewing;

FIG. 4 is a schematic diagram showing configuration methods of the smart lock structure in accordance with embodiments of the present invention;

FIG. 5 is a schematic diagram showing the smart lock structure in operation after configuration thereof in accordance with embodiments of the present invention;

FIGS. 6A-6D are schematic block diagrams respectively showing embodiments of the smart lock structure in accordance with the present invention;

FIG. 7 is a schematic diagram showing an operation table of the smart lock structure in accordance with embodiments of the present invention, listing relationship between switches of the smart lock structure and operation modes and functions thereof;

FIG. 8 is a schematic flow chart illustrating an operation method of the smart lock structure of the present invention in its configuration mode in accordance with embodiments of the present invention;

FIG. 9 is schematic flow chart illustrating an operation method of the smart lock structure of the present invention in its normal operation mode in accordance with embodiments of the present invention;

### DETAILED DESCRIPTIONS OF THE EMBODIMENTS

To further explain technical solutions adopted in the present invention and advantages thereof, a detailed description is given to preferred embodiments of the present invention for better understanding referring to the attached drawings.

The present invention is applicable to any conventional lock systems incorporating with a Radio Frequency (RF) interrogating device. An authorized user can lock or unlock a door, a locker, or gain an access to a particularly secured asset or area by interacting with the Radio Frequency (RF) interrogating device and the lock systems. Without complicated computer systems or databases simultaneously supporting behind, the present invention works alone to be as simple as any conventional locks for household usages or commercial applications.

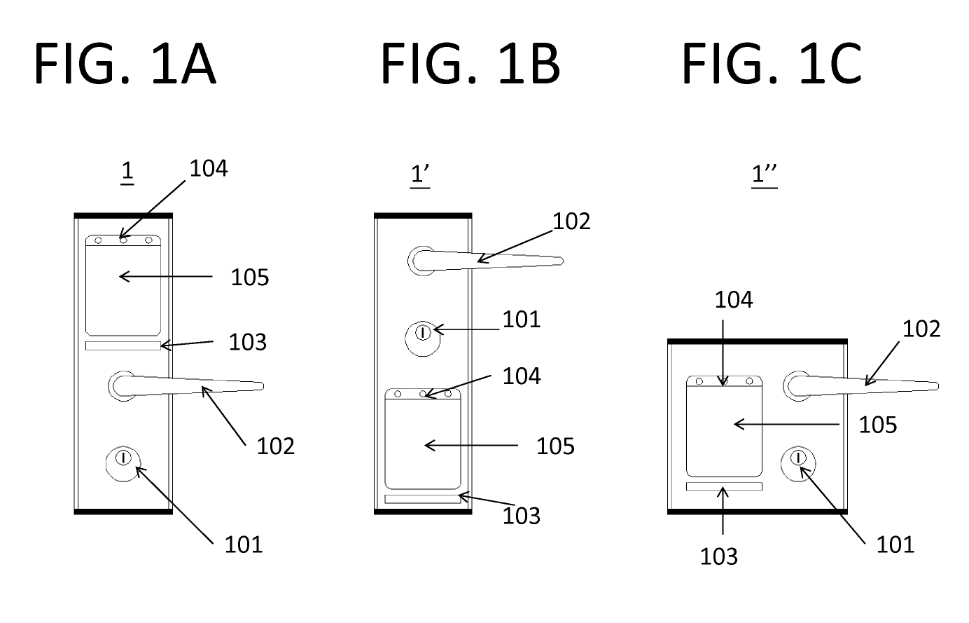

FIGS. 1A-1C depict respectively a smart lock structure of the present invention. At the outdoor side of a door, a locker or any access of a secured asset or area, referring to FIG. 1A, the smart lock structure 1 of the present invention comprises a physical key hole 101 and an interrogating device 105 using one of radio frequency (RF) technologies such as Near Field Communication, Bluetooth, Infra Red Communication, and/or other wireless communication protocols, and being embedded transmitting and receiving antennas. A handle or a knob 102 is optionally disposed at the location depicted in FIG. 1A. At the indoor side of the door, locker or access to the secured asset or area, the smart lock structure of the present invention is optionally equipped with a handle, a turnknob, an Ethernet port, a Serial port, a power input hole, a USB port, and/or two switches for configuration and for activating mobile control (Not Shown).

In embodiments of the smart lock structure of the present invention with a handle or a knob as shown in FIGS. 1A, 1B and 1C, the smart lock structure l′ or 1″ is shown to dispose the interrogating device 105 at a top thereof (Referring to FIG. 1A), a left thereof (Referring to FIG. 1C), or a bottom thereof (Referring to FIG. 1B) corresponding to locations of the handle 102 and the key hole 101 at the outdoor side assuming the door/locker/access is open at a left-handed side. Everything mentioned above is understandably horizontally reversed while the door/locker/access is open at a right-handed side thereof.

An LED (Light Emitting Diode) light indicator 104 is disposed at a top side of the interrogator device at the outdoor side. LEDs comprised in the light indicator are used to indicate respectively an interrogator operation status, a power or battery status of the smart lock structure, and/or a status depicting whether an access is granted.

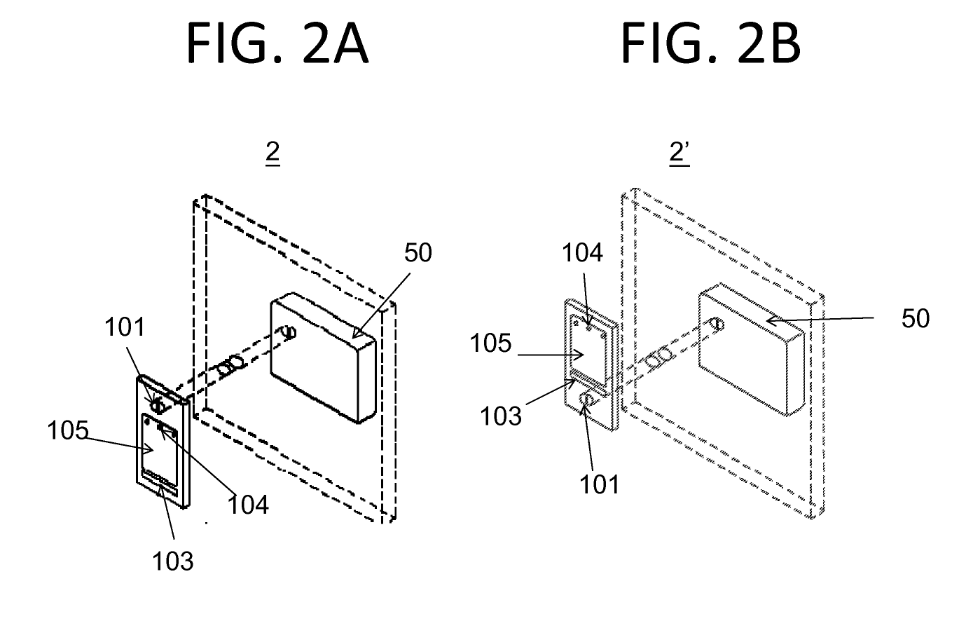

FIGS. 2A and 2B show embodiments of the smart lock structure of the present invention without a handle/knob. In the embodiments of the smart lock structure without a handle or knob as shown in FIGS. 2A and 2B, the smart lock structure 2 or 2′ is shown to dispose the interrogating device 105 at a bottom thereof or below the physical key hole 101 (Referring to 2A), or at a top thereof or above the physical key hole 101 (Referring to 2B), as depicted at an outdoor side. The smart lock structure 2, 2′ is controllably connected and communicates with locks of the door/locker/access through the physical key hole 101.

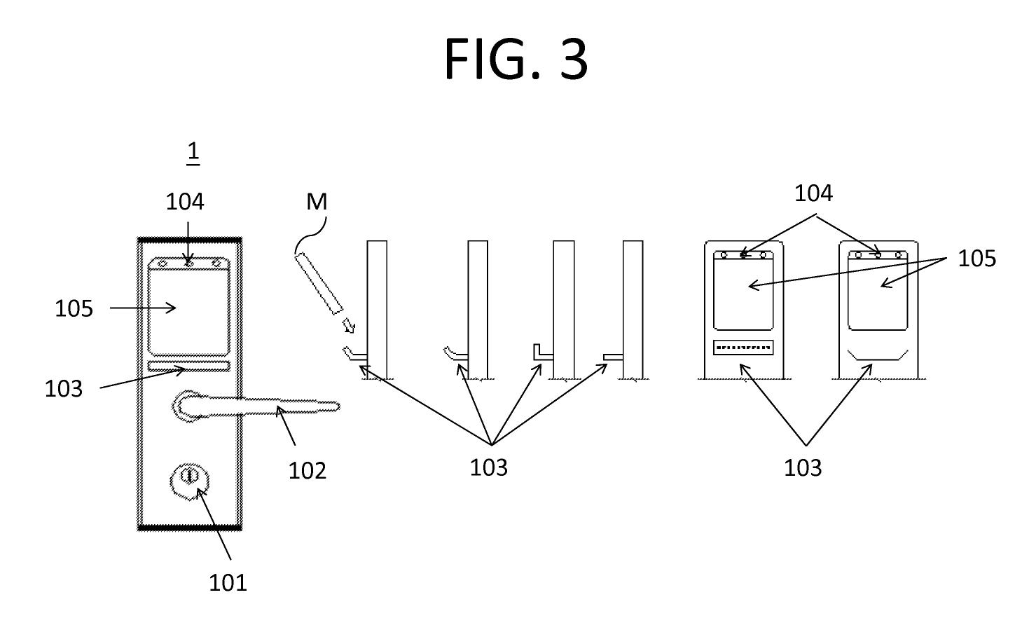

FIG. 3 shows a falling proof device 103 of the smart lock structure 1 of the present invention while the falling proof device 103 is disposed at a bottom of the interrogating device 105. The falling proof device 103 is preferably an edge protrusive from the smart lock structure 1 to prevent an accidental falling of a mobile phone M while dipping the mobile phone M near the interrogating device 105 to unlock the door. The falling proof device 103 is made to be wider and thicker than the mobile phone M. The falling proof device 103 is alternatively an edge of being flat, in shape of a fillister with slopped or curved walls, as respectively depicted at the right-handed side of FIG. 3.

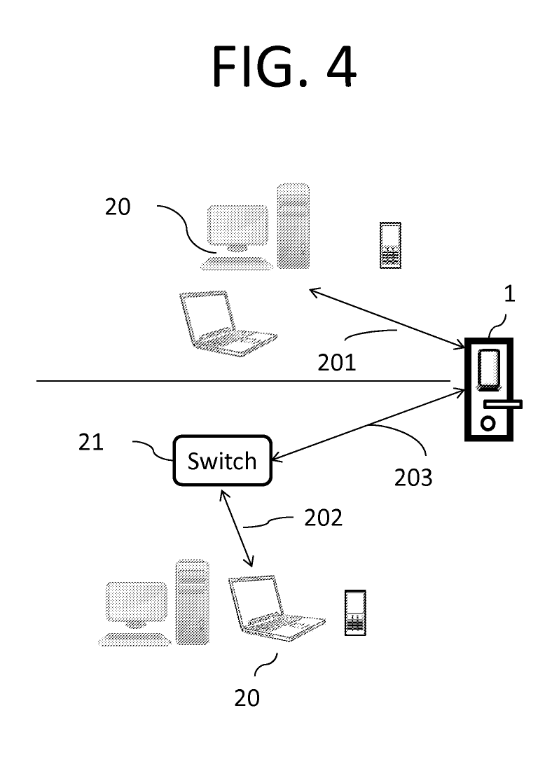

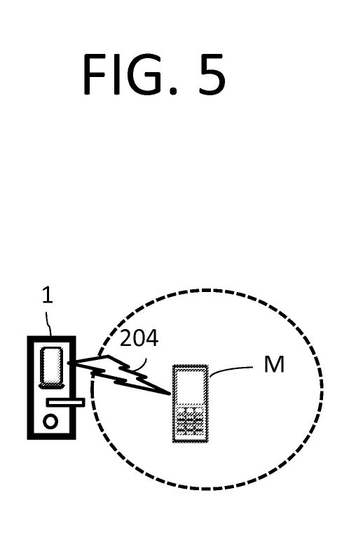

FIG. 4 illustrates respectively two architecture diagrams of configuring the smart lock structure 1 of the present invention according to embodiments of the present invention. FIG. 5 illustrates a diagram showing the smart lock structure 1 of the present invention is in operation after its configuration according to embodiments of the present invention.

Referring to FIG. 4, in configuration of the smart lock structure 1, a user creates a permission list into a database of the smart lock structure 1 of the present invention by a configuring device 20 such as a desktop computer, laptop computer, panel computer, mobile phone, or any kind of mobile devices. The smart lock structure 1 incorporates only one configuring device at one time.

The configuration processes shown in FIG. 4 can be done with Internet Network connection (as shown in the bottom half of FIG. 4) or without Internet Network connection (as shown in the top half of FIG. 4). In the embodiment without Internet Network (as shown in the top half of FIG. 4), the configuring device 20 directly communicates with the smart lock structure 1 through communicable connection 201 such as a USB (universal serial bus) port, a serial port (RS-232/422/485), Bluetooth, or Near Field Communication (NFC). In the embodiment with Internet Network (as shown in the bottom half of FIG. 4), the wired or wireless switch 21 develops a Local Area Network (LAN), linking the configuring device 20 through communicable connection 202 such as a wired Ethernet port or wireless Wi-Fi or Zig-Bee, and linking the smart lock structure 1 through communicable connection 203 such as an Ethernet port, Power over Ethernet port, or wireless Wi-Fi or Zig-Bee.

During the configuration mode of the smart lock structure 1 as shown in FIG. 4, an authorized user creates or modifies the permission list allowing any specific identity to access permissible resources and save the permission list in the database of the smart lock structure 1. The permission list also embraces at least one of authentication information such as user names, passwords, NFC tag information, mobile phone numbers, serial numbers of the mobile phone/mobile device M, MAC (Media Access Control) number of the mobile phone/mobile device M, ICCID (Integrated Circuit Card Identification) of the mobile phone/mobile device M, IMEI (International Mobile Equipment Identity) of SIM (Subscriber Identity Module) cards used in the mobile phone/mobile device M, biometric authentication such as voice recognition and face recognition, and/or valid periods of permissible access.

After configuration of the smart lock structure 1 is done, access of the database in the smart lock structure 1 is completely disconnected from the configuring device 20. Further referring to FIG. 5, in operation of the smart lock structure 1 after configuration thereof, the smart lock structure 1 works independently and stand-by. With a mobile device M equipped Radio Frequency communicating function, a user whose authentication information is previously configured in the permission list in the database of the smart lock structure 1 can acquire access by contactless interacting the smart lock structure 1 with the mobile device M located within an effective range of Radio Frequency communication 204 of the interrogating device 105 disposed on the smart lock structure 1.

The Radio Frequency communication 204 between the smart lock structure 1 and the mobile device M is performed by Near Field Communication, Bluetooth, Infra Red Communication, and/or other wireless communication protocols.

According to information transmitted from the mobile device M, the smart lock structure 1 will verify authentication information according to that in the previously saved database. If authentication data are identified and verified as matched, the smart lock structure 1 sends an electronic signal to a lock system of the door to unlock the door. Otherwise, access of users will be denial and the smart lock structure 1 will send a denial information, reclaim another set of unlock requests, delay accepting another unlock request, temporarily shut down unlock function via the Radio Frequency interrogating device 105, or permanently turn off the unlock function via the Radio Frequency interrogating device 105 until another physical key is used to unlock the door instead and reconfigure the smart lock structure 1 using methods depicted in FIG. 4.

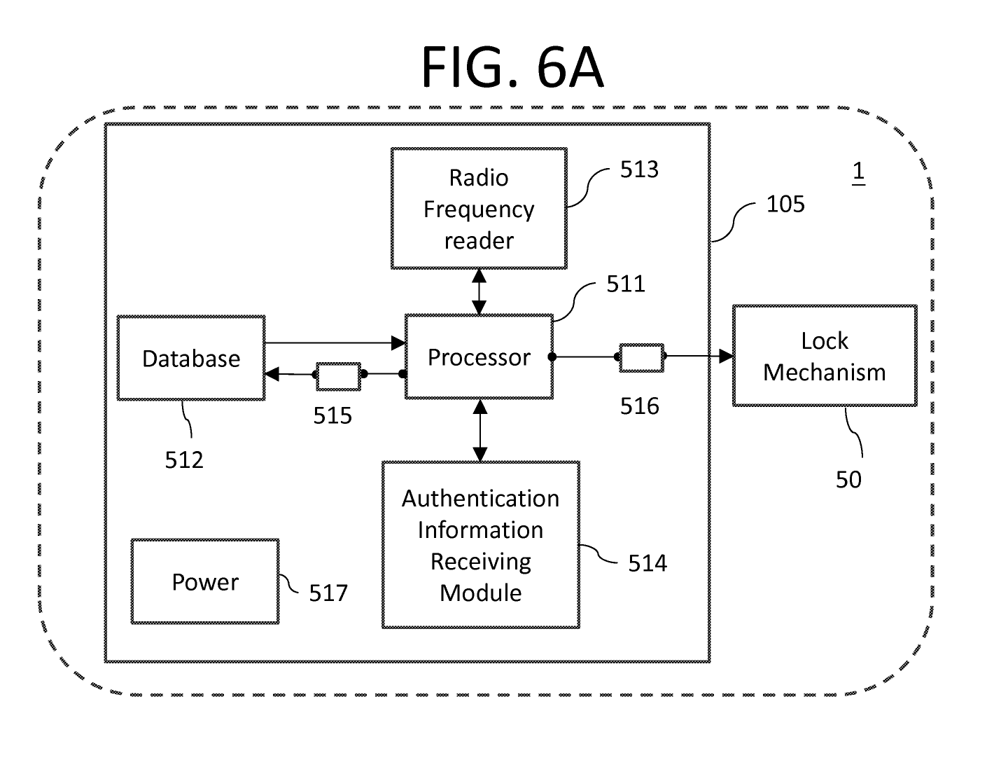

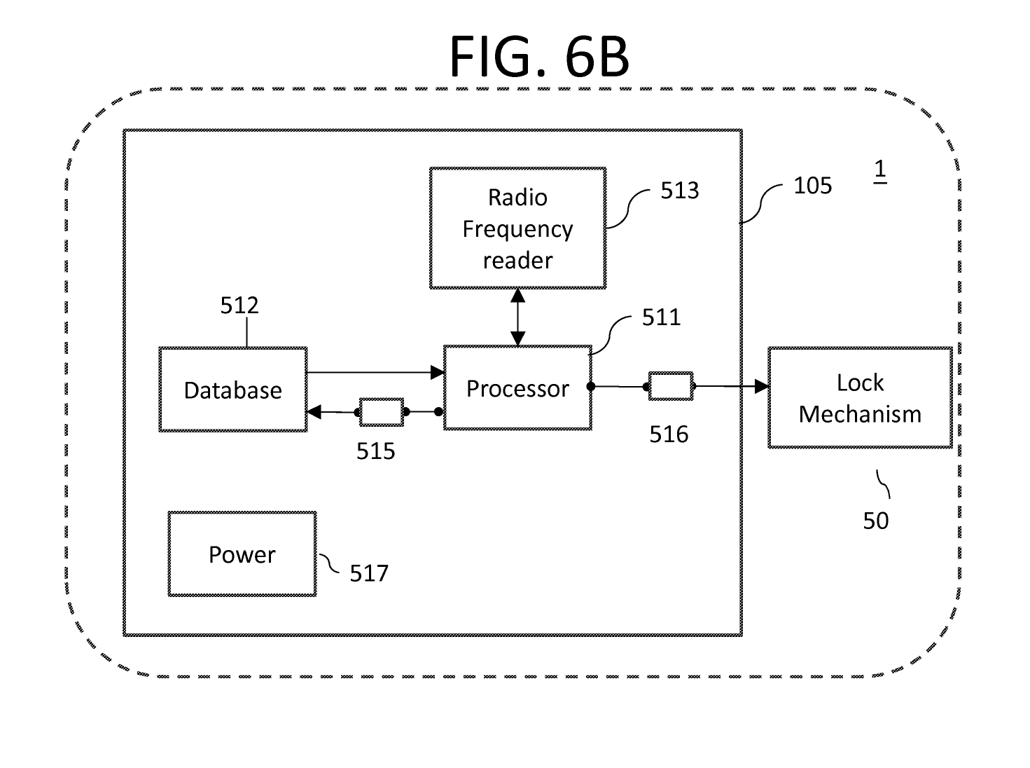

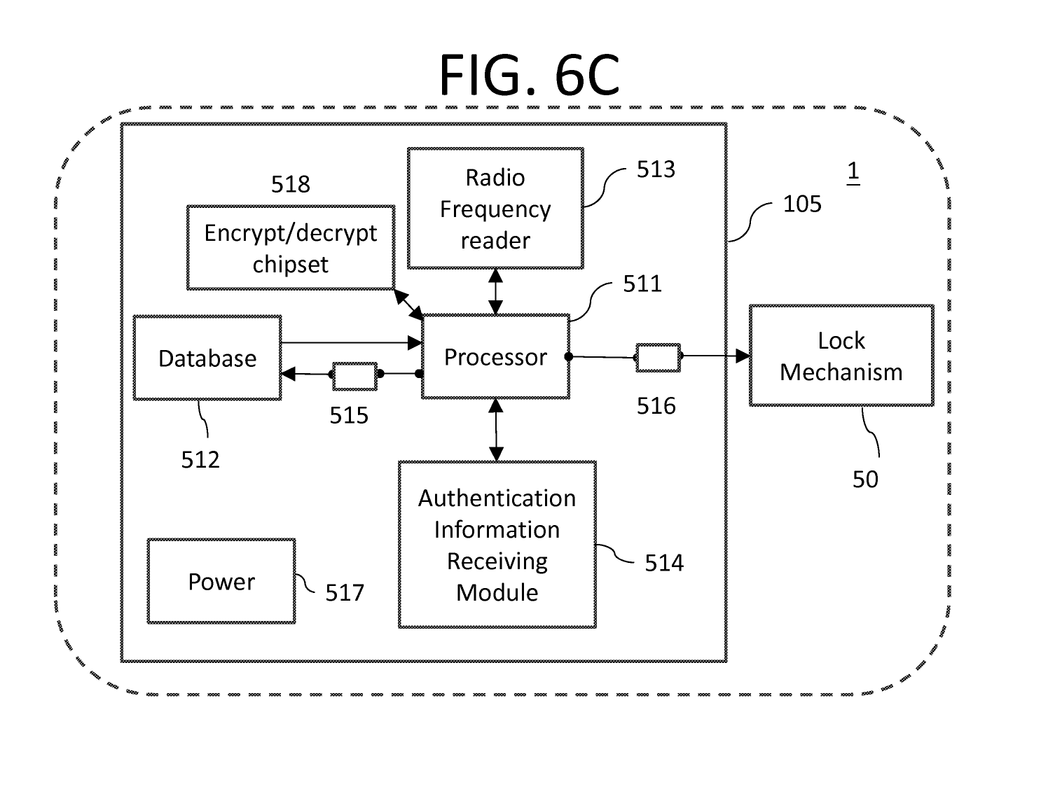

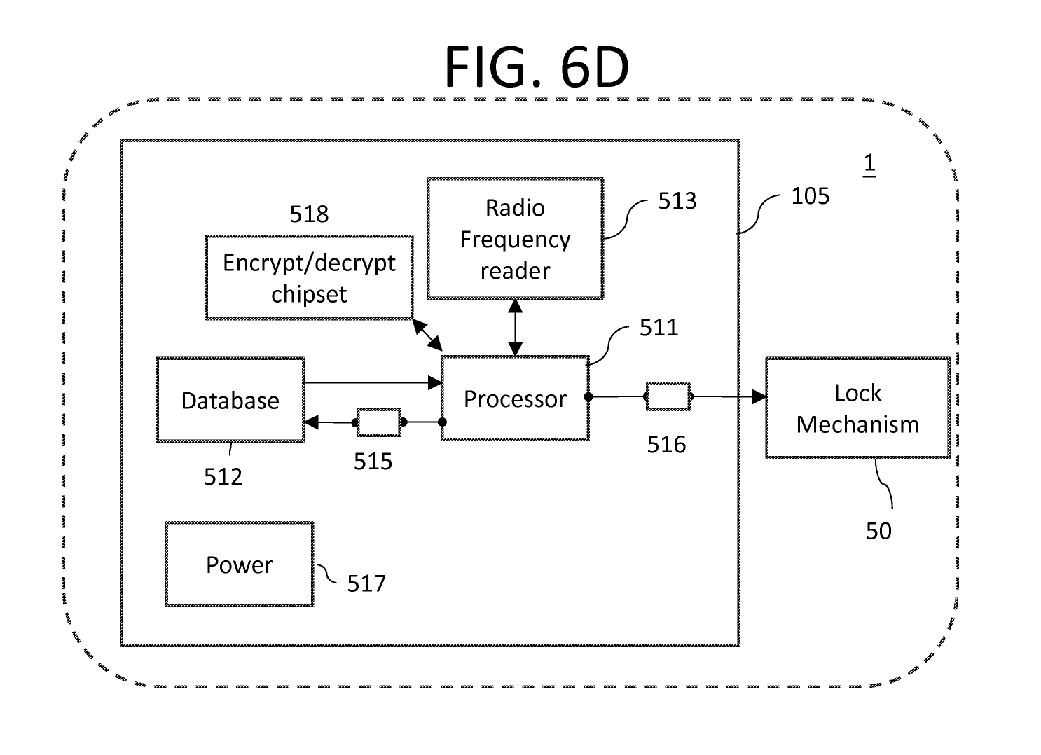

FIG. 6A illustrates a block diagram of a first embodiment of the smart lock structure 1 of the present invention. The smart lock structure 1 comprises a Radio Frequency (RF) interrogating device 105 as mentioned above and a lock mechanism 50 which can be an ordinary lock having the key hole 101 as mentioned above. The Radio Frequency interrogating device 105 comprises a processor 511, a database 512 created by/in a memory, a radio frequency reader 513, a module 514 for receiving authentication information, two switches including a configuration switch 515, and a key-mobile switch 516 for controlling a path of sending electronic signals as an unlock command to the lock mechanism 50, a power 517, and/or optionally a chipset 518 as shown in FIGS. 6C and 6D to encrypt or decrypt data transmitted through the radio frequency reader 513.

In a configuration mode of the smart lock structure 1, the processor 511 decrypts data from the module 514 for receiving authentication information and saves the data by being encrypted to prevent unauthorized reading/writing on the data saved in the database 512. During a normal operation mode of the smart lock structure 1, the processor 511 encrypts data to, or decrypts data from the radio frequency reader 513, then identify authentication information between the one saved in the database/memory 512 and the one retrieved out of data received from the radio frequency reader 513. Afterwards, the processor 511 sends an unlock command to the lock mechanism 50 based on a result of identifying authentication information. The processes of encryption and decryption are conducted by either software in the processor 511 or hardware of the chipset 518 specifically used for encryption and decryption as shown in FIGS. 6C and 6D.

The database/memory 512 loads all authentication database such as user names, passwords, NFC tag information, mobile phone numbers, series numbers of mobile devices, MAC numbers of mobile devices, ICCIDs of mobile devices, IMEIs of SIM cards, biometric authentication such as voice and face recognition, and/or valid periods of access. The database 512 in the memory comprises multiple accounts in a permission list. The access history is recorded into the memory as well. The database/memory 512 is a non-volatile RAM (Random access memory) or other magnetic storages, which keep the secured data with or without power supplied.

Working under Near Field Communication, Bluetooth, Infra Red Communication, and/or other wireless communication protocols as well known in the art, the radio frequency reader 513 is designed to communicate with an outside mobile device M (Mobile phones, PDAs, Panel Computers, Tablets), which requests to unlock the door controlled by the smart lock structure 1. The module 514 for receiving authentication information receives authentication data through an Ethernet port, Power over Ethernet Port, Wireless Wi-Fi module or Zig-Bee at 2.4 GHz under IPv4 or IPv6, reader of Near Field Communication at 13.56 MHz, Bluetooth, USB port, and/or Serial port of RS-232, 422, 485. The main function of the module 514 is to collect authentication information of the permission list.

In an alternative embodiment, the radio frequency reader 513 also plays a role as an authentication receiving module, and consequently the corresponding block diagram is simplified as shown in FIGS. 6B and 6D.

The key-mobile switch 516 is a switch to enable/disable the Radio Frequency interrogating device 105 over the lock mechanism 50. When the switch 516 turns to the “Key and Mobile” mode, unlocking through the Radio Frequency interrogating device 105 is allowed. In case that the switch 516 turns to the “Key Only” mode, the communication between the Radio Frequency interrogating device 105 and the lock mechanism 50 is turned off, demoting the smart lock structure 1 to ordinary door locks. However, a user is always able to unlock the lock mechanism of the smart lock structure 1 with its corresponding physical key under both modes.

The configuration switch 515 is an implement to prevent unauthorized modification on the permission list through any Internet or wireless connection. If and only if the user is physically present to the smart lock structure 1 and personally switches the smart lock structure 1 to its configuration mode, modification over the database 512 by the processor 511 is allowed.

The key-mobile switch 516 interacts the configuration switch 515 as well. If the configuration switch 515 turns on, the key-mobile switch 516 automatically switches to its “Key Only” mode. Thus, sending an electronic signal as the unlock command to the lock mechanism 50 under the configuration mode of the smart lock structure 1 is accordingly blocked. During the configuration mode, unlocking the lock mechanism 50 only can be done with a physical key.

After key-in all information of the permission list, the configuration switch 515 has to be switched to its “Normal” operation mode, under which database of the permission list cannot be modified anymore. Meanwhile, if the key-mobile switch 516 turns on to its “Key and Mobile” mode, the processor 511 of the smart lock structure 1 is allowed to send unlock commands to the lock mechanism 50.

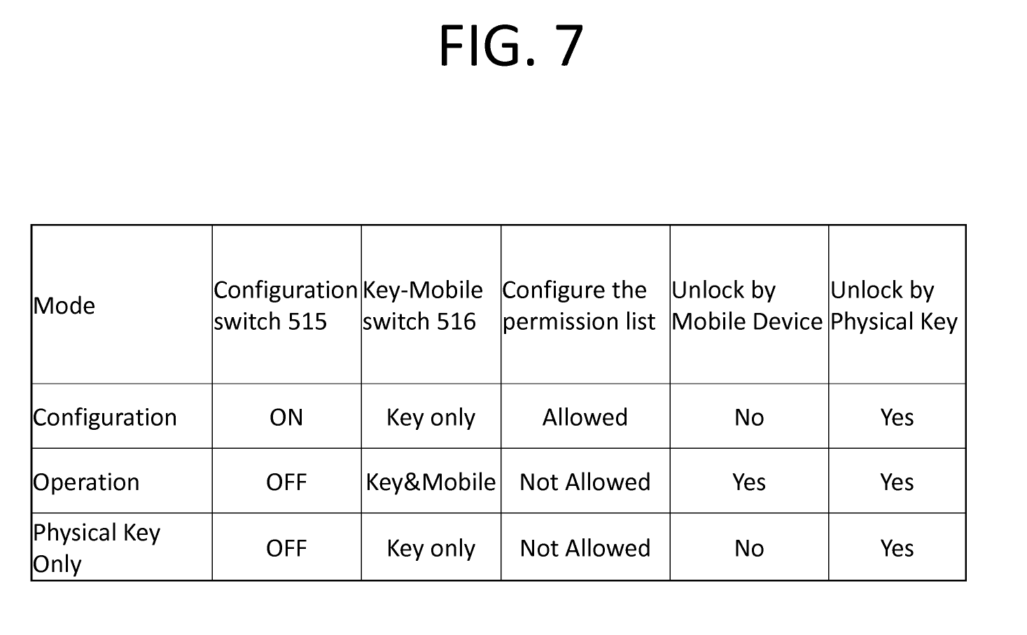

FIG. 7 shows an operation table illustrating relationship between three operation modes, switches of the smart lock structure 1 and unlock mechanism thereof. The configuring switch 515 and the key-mobile switch 516 can be automatically or manually performed by hardware or software. Connecting/disconnecting the configuring device 20 to the module 514 for receiving authentication information of the smart lock structure 1 automatically enables/disables the configuration mode of the smart lock structure 1. Moreover, a user is able to set up an available schedule of mobile key, based on which the smart lock structure 1 can be automatically switched between its “Key Only” mode and “Key and Mobile” mode.

The lock mechanism 50 is alternatively able to comprise spring-loaded latches to be retracted by a lever and deadbolts extended (i.e. the handle 102 as described above) and retracted by keys or turnknobs (Not Shown). Both or either the latches and/or deadbolts is controlled by the Radio Frequency interrogating device 105 in its normal operation mode with the switch 516 on its “Key and Mobile” mode.

The smart lock structure is able to be powered by a power 517 using direct electrical currents from rechargeable battery, alternative electrical currents, power via IEEE 802.3 of or 802.3 at PoE standard, or power from rechargeable handles, i.e., swinging the handle 102 on the smart lock structure 1 to generate required power (only for embodiments of the smart lock structure 1 equipped with handles). Designed for emergency, the power 517 generated from rechargeable handles is tiny and for one time unlocking use only.

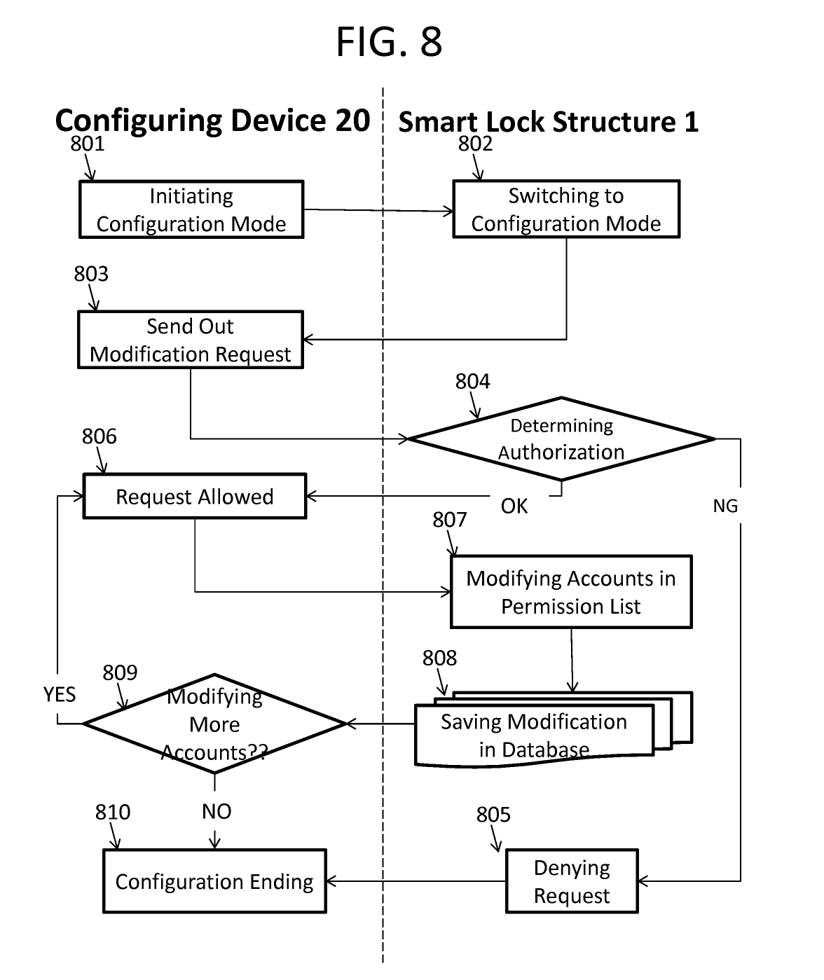

FIG. 8 depicts a flow chart of the present invention illustrating an operation method used between the configuring device 20 and the smart lock structure 1 in its configuration mode.

The configuring device 20 is selective from one of a laptop computer, desktop computer, Panel computer, tablet or mobile phone equipped with functions of Ethernet/Wi-Fi/Zig-Bee, Bluetooth, Serial Port (RS-232,422,485), and/or Near Field Communication. During the configuration mode of the smart lock structure 1, in a configuration initiation step 801, both of the configuring device 20 and the smart lock structure 1 must be turn on to their configuration modes. In software initiation step 802, a Smart Key software is required to be running on the configuring device 20.

In a request step 803, through a Local Area Network, USB port, Serial port (RS-232/422/485), Bluetooth, or Near Field Communication, a mobile device or configuring computer used as the configuring device 20 sends a configuring request to the smart lock structure 1 with passwords to create, modify, or delete accounts of the permission list in the database 512 of the smart lock structure 1.

In a determining step 804, after receiving the configuring request from the configuring device 20, the smart lock structure checks and determines if the user is allowed to access the database 512. If the request is from unauthorized users, in a denying step 805, the smart lock structure 1 sends commands to deny the request, to send a warning to authorized users or affiliated secure authority, and/or to record the unsuccessful modification request. If the request is from authorized users with correct passwords, in an allowing step 806, the smart lock structure 1 allows the modification request. In a modifying step 807, the allowed user creates an account and keys in user names, mobile phone numbers, passwords, series numbers of the mobile device M, MAC number of the mobile device M, ICCID of the mobile device M, IMEI of SIM cards, and/or valid periods of authorization for any access, and in a saving step 808, modification mentioned above is saved onto the permission list in the database 512 of the smart lock structure 1 as authentication information for any access request in the future. Moreover, the smart lock structure 1 automatically generates a cryptographic key saved in both of the mobile device M and itself.

After configuration, if the configuring mobile device 20 is the exactly same mobile device M that unlocks the smart lock structure 1, all related identification information and IDs (identifications) for using the smart lock structure 1 is saved into another database of the Smart Key software in the mobile device 20 so as to become one of keys to unlock. In an opening procedure for the mobile device, the mobile device 20 will access its database for the key to unlock.

In case that the configuring device 20 authorizes another mobile device M for door entrance, the configuring mobile device 20 sends secured authentication and the IDs for using the smart lock structure 1 to the specific mobile device M, which is used to unlock the smart lock structure 1 by the Smart Key software, i.e., after successful configuration, the Smart Key software in the configuring device 20 encrypts and uploads the identification information to a specific server on Wide Area Network (WAN) by the Internet or mobile wireless communication. The server then generates an internet link set toward the identification information on the server and forwards the link to a prospective user by e-mail and/or Short Message Service. While receiving the link, the prospective user simply clicks the link to synchronize the target ID and authentication information for using the smart lock structure 1 into a database of a Smart Key software in the user's mobile device M. To verify the authentication, the Smart Key Software in the mobile device M double checks mobile phone numbers, passwords, series numbers of the mobile device M, MAC numbers of the mobile device M, ICCID of the mobile device M, or IMEI of SIM cards with those in the mobile device M. Once the data is matched, authorization of the mobile device M for using the smart lock structure 1 is completely granted.

Multiple accounts for the permission list are able to be created by a repeating step 809 of repeating the allowing step 806. The database can be modified unlimited times under the configuration mode of the smart lock structure 1 if being asked by the authorized user. In a terminating step 810, the configuration mode of the smart lock structure 1 can be terminated by the configuration switch 515 being turned off.

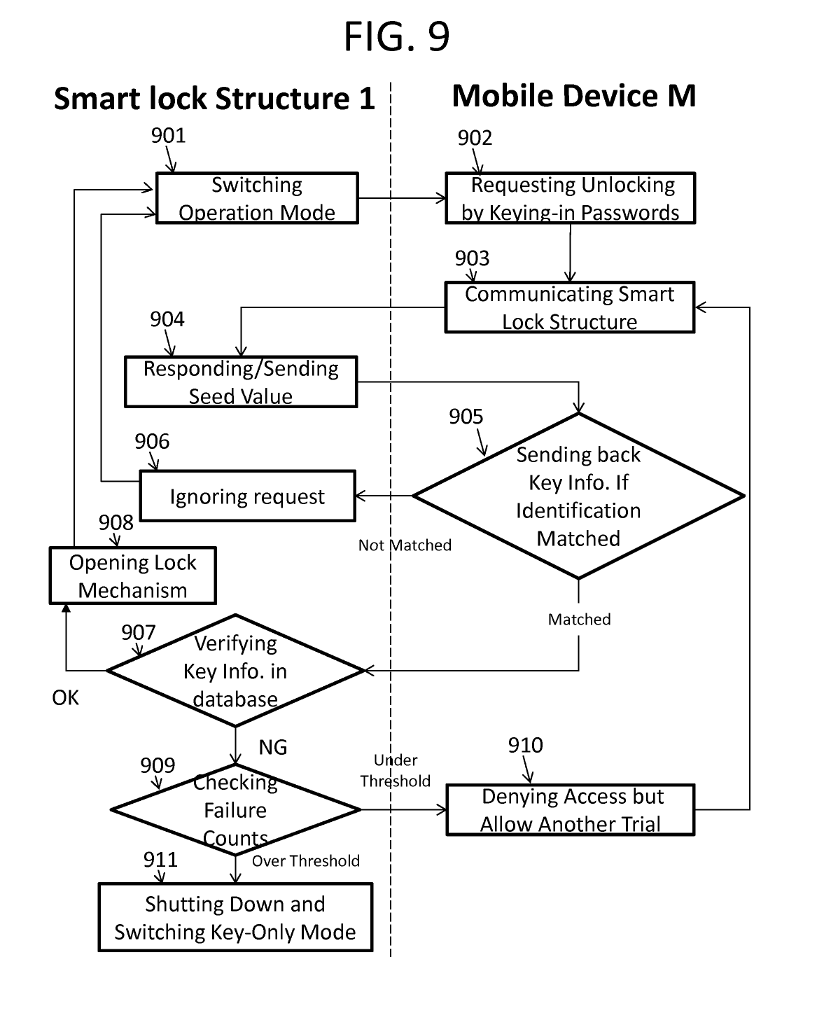

FIG. 9 is a flow chart of an operation method of the present invention explaining interaction between the smart lock structure 1 of the present invention and the mobile device M with the Smart Key software installed as wireless keys in an operation mode, or normal mode of the smart lock structure 1 while a user tries to unlock the smart lock structure 1.

During the normal operation, in a start step 901, the smart lock structure 1 is powered under its configuration mode being off and the Radio Frequency interrogating device 105 standing-by. While a user intends to unlock the smart lock structure 1, in a requesting step 902, the user turns on the Smart Key software installed in the mobile device M, keys in required passwords as a request to unlock, and presents the mobile device M within an effective transmission range of the Radio Frequency interrogating device 105 embedded in the smart lock structure 1.

In a communication step 903, in order to control the smart lock structure 1, the Smart Key software in the mobile device M communicates the smart lock structure 1 via the Radio Frequency interrogating device 105 thereof through Near Field Communication, Bluetooth, Infra Red Communication, and/or any other wireless communication protocols. In response to the request from the mobile phone M, in a responding step 904, the smart lock structure 1 responds with a seed value embracing respective identification and time information of the smart lock structure 1 and the mobile device M for encryption purpose. In a sending-back step 905, the Smart Key software then chooses key information, which matches the identification of the smart lock structure 1 in the seed value, from the database of the mobile device M. Through the Radio Frequency reader 513, the Mobile Device M will send back encrypted key information as previously configured, including user names, passwords, mobile phone numbers, series numbers of the mobile device M, MAC numbers of the mobile device M, ICCID of the mobile device M, and/or IMEI of SIM cards.

If identification information of the smart lock structure 1 is not in the database of the mobile device M, in an ignoring step 906, the mobile device M shows access denial on the mobile device M, and the Smart Lock Structure 1 directly ignores the request, and go back to stand-by mode 901.

In a verifying step 907, the smart lock structure 1 decrypts the key data sending from the mobile device M and identify the permission list in the database 512. If the decrypted information/data are all perfectly match one of listed information in the database 512, in an unlocking step 908, the smart lock structure 1 sends an electronic signal as an unlocking command to the lock mechanism 50 for granting access of specific resources or assets for the user. Afterward, the smart lock structure 1 returns to the start step 901 to be in a stand-by mode and to wait for a next request from any mobile device M.

A protection mechanism is activated if the decrypted information fails to match any identity in the permission list in the database 512. While data is unmatched, the smart lock structure 1 counts failure time and informs the user by showing fail messages on the mobile device M to deny the user's request. In case that failure happens less than a threshold value, the smart lock will go back to the communication step 903, allowing another trial.

In attempt to stop relay attack by a malice intruder, who probably generates massive radio signals by a programmable wireless device, in a checking step 909, the smart lock structure 1 counts failures of unlocking request through the Radio Frequency interrogating device 105. In case that the smart lock structure 1 detects failures abnormally increase over the preset threshold value during a preset period of time, the smart lock structure 1 accumulates time intervals to delay processing of a next open request by the mobile device M.

Even worse, when the malice invasion continuously occurs in a certain period of time, in a shutting-down step 911, the smart lock structure 1 shuts down its wireless unlock mechanism and only physical keys can open the door. Performing of the steps 909 and 911 is considered as an Intrusion Prevention System, or “IPS” for the smart lock structure 1.

Installed by computers or downloaded from any mobile APP platform, the Smart Key software in the mobile device M is designed to configure and unlock the smart lock structure 1, encrypt communications between the Radio Frequency interrogating device 105, identify user's authentication, select keys, read entry records, or monitor a battery status of the smart lock structure 1.

In the normal/operation mode, encryption and decryption of Radio Frequency (RF) signals through Radio Frequency communication 204 as shown in FIG. 5 is done by the Smart Key software in the mobile device M and the smart lock structure 1. The detail encryption and decryption procedures of the Radio Frequency communication are illustrated as below.

During an open procedure of the operation/normal mode, after the mobile device M confirms a response from the smart lock structure 1, the Smart Key software then identifies the smart lock structure 1 in a database of the mobile device M, finds out and encrypts corresponding authentication information in order to prevent eavesdropping or data modification.

To prevent eavesdropping, by which attacker simply record and copy the radio frequency to confuse the interrogating device 105 of the smart lock structure 1, encryption of the interrogating device 105 such as an Interrogating Device adopts time permutation of data sequences.

In the communication step 903 and the responding step 904, the mobile device M and the smart lock structure 1 synchronize time between each other. The synchronized time becomes a part of a seed value for incoming encryption. In the sending-back step 905, the Smart Key software encapsulates account names, authentication information, and passwords into different blocks and fills out empty space with pseudo random data. A function, which predefines a given time in the seed value corresponding to a relative sequence of these data blocks, is embedded in both of the Smart Key software and the interrogating device 105 of the smart lock structure 1 in advance. Based on the predefined function, the Smart Key software permutes the sequence of these data blocks. Consequently, the corresponding radio frequency of successful unlocking in different times is unlikely be identically same in a certain time interval, thus an unauthorized intruder cannot gain any access simply by copying the radio frequency of a previously successful unlocking in a short period of time.

If an unauthorized intruder keeps sending the copied radio signals from a previously successful unlocking/entry, the interrogating device 105 of the smart lock structure 1 is automatically blocked by “Intrusion Prevention Mechanism” as depicted previously from the checking step 909 to the shutting-down step 911 after the time of failures is over a preset threshold value.

To prevent any data modification, wireless communication between the mobile device M and the smart lock structure 1 can apply either symmetric-key cryptography or asymmetric-key cryptography to encrypt their transmitting data as a second/next step in encryption.

During the saving step 808 of the configuration mode, the Smart Key software generates a pair of private keys for encryption and decryption saved in both of the mobile device M and the smart lock structure 1 using a streaming cipher method. No other mobile device M or user shares a same cryptographic key used in one smart lock structure 1 or the Interrogating Device 105 thereof. In case that a block cipher method is also applied under symmetric cryptography, multiple pairs of keys for respective authentication data blocks are saved in both of the mobile device M and the smart lock structure 1.

The symmetric-key cryptography includes Twofish, Serpent, Blowfish, Data Encryption Standard, 3DES, CAST5, RC4, IDEA, Advanced Encryption Standard, or any algorithm well known as symmetric-key cryptography.

In some commercial embodiments, there are too many users share one Interrogating Device 105 or distribution of a private cryptographic key is technically or commercially difficult. Alternatively, asymmetric-key cryptography is applied in these embodiments. A pair of a cryptographic public-key for encryption and a private-key for decryption is set up in advance. The private key is installed in the Interrogate Device 105 to decrypt data from the mobile device M. The corresponding public-key is embedded in the Smart Key software downloaded in the mobile device M to encrypt transmitting data.

Once a user is granted by any authority to enter a special area guarded by the Interrogating Device 105 of the smart lock structure 1, he or she gets encrypted data read only by the Smart Key software via e-mail and/or Short Message Service. To verify authentication, the Smart Key Software in the mobile device M double checks the received information including mobile phone numbers, passwords, series numbers of the mobile device M, MAC numbers of the mobile device M, ICCID of the mobile device M, or IMEI of SIM cards with those in the received mobile device M. Once the received data is matched, authorization of the mobile device M is completely granted. While the granted mobile device M presents in an effective range of the Interrogating Device 105, the Smart Key software encrypts authentication information by the cryptographic public-key and sends to the Interrogating Device 105 in step 905 to 907 for identification.

The cryptographic private-key in the Interrogating Device 105 and any new software embracing corresponding public key can be updated regularly.

The asymmetric-key cryptography includes RSA, El Gamal, Diffie-Hellman key exchange protocol, DSS (Digital Signature Standard), Various elliptic curve techniques, Various password-authenticated key agreement techniques, Paillier cryptosystem, Cramer-Shoup cryptosystem, or any algorithm well known as asymmetric-key cryptography.

Reversely, the Interrogating Device 105 on the smart lock structure 1 decodes data transmitted by symmetric or asymmetric cryptographic keys previously saved in the database 512, as depicted in the saving step 808, matches the decoded data with original authentication information and passwords, and interrogates the received data within the permission list thereof. This decryption is performed by the processor 511 or the decryption/encryption chipset 518.

The Interrogating Device 105 with above described encryption methods is installed not only in the smart lock structure 1 but also in a vending machine, ticket system or public access control system. With authorized access from software in a mobile device, the user can access to particular assets, areas, or resources controlled by the Interrogating Device 105.

A mobile device M is stored with plural keys sets in the Smart Key software in order for unlocking respective smart lock structures 1. As presenting near by the smart lock structure 1, one of the keys set in the mobile device M for the respective smart lock structure 1 is capable of being chosen manually, vocally, or automatically according to identifying data provided by the particular smart lock structure 1, or according to location services via GPS, crowd-sourced Wi-Fi hotspot, or cell tower locations.

Losing the mobile phone M with the Smart Key software probably opens access to any unauthorized finder who pretends as an authenticating entity. To enhance security thereof, the Smart Key software can be set to request passcodes, passwords or biometric authentication such as voice or face recognition to activate the smart key software or to unlock the smart lock structure 1.

With proper authorization, the user can use the Smart key software to read access records in the smart lock structure. Alarm or instant update of unauthorized/unsuccessful entry from the smart lock structure 1 can be sent to an administrators' mobile phone by the internet or GSM. Also, the user can be informed with the battery status of the smart lock structure 1 from the Smart Key software of the mobile device M.

It is understood that the invention may be embodied in other forms within the scope of the claims. Thus the present examples and embodiments are to be considered in all respects as illustrative, and not restrictive, of the invention defined by the claims.

What is claimed is:

1. A smart lock structure, comprising:
a key hole for access keys to unlock the smart lock structure for access to secured areas;
an interrogating device for configuring a permission list of users for the access secured by the smart lock structure and for using radio frequency technology to communicate with a mobile device and accept access requests from the mobile device to unlock the smart key structure other than using the access keys on the key hole, the interrogating device comprising:
a radio frequency reader to transmit and receive radio frequency data for communication with the mobile device;
a processor to decrypt and encrypt authentication information retrieved from the mobile device via the radio frequency reader to prevent unauthorized reading/writing, and to save the encrypted authentication information during configuration of the smart lock structure, the processor further, during normal operation of the smart lock structure, to encrypt to and decrypt data received from the mobile device via the radio frequency reader, to identify authentication information retrieved out of the received data, and to send out an unlock command for unlocking the smart lock structure based on a result of identifying the authentication information; and
a database in form of a memory to save the encrypted authentication information for use of the processor; and
a lock mechanism in response to at least one of interaction between the key hole and the access keys and communication between the interrogating device and the mobile device for unlocking the smart lock structure and gaining the access.

2. The smart lock structure as claimed in claim 1, further comprising a falling proof device equipped beside the interrogating device to prevent falling of the mobile device when the mobile device is used to communicate with the interrogating device.

3. The smart lock structure as claimed in claim 1, wherein a seed value is provided to the processor from the mobile device, a permutation function is preset in the database for use of the processor to permute data sequences of the authentication information based on the seed value and for use of the processor to further encrypt and decrypt the authentication information.

4. The smart lock structure as claimed in claim 1, wherein the interrogating device further comprises a module for receiving authentication information before being saved during the configuration of the smart lock structure.

5. The smart lock structure as claimed in claim 1, wherein the interrogating device further comprises a configuration switch to allow the configuration of the smart lock structure.

6. The smart lock structure as claimed in claim 1, wherein the interrogating device further comprises a key-mobile switch for controlling a path of the interrogating device sending an unlock command to the lock mechanism.

7. The smart lock structure as claimed in claim 1, wherein the interrogating device further comprises a chipset to encrypt or decrypt the data transmitted or received through the radio frequency reader.

8. A smart lock structure, comprising:
a key hole for access keys to unlock the smart lock structure for access to secured areas;
an interrogating device for using radio frequency technology to communicate with a mobile device and accept access requests from the mobile device to unlock the smart lock structure other than using the access keys on the key hole;
a falling proof device equipped beside the interrogating device in a gravity falling way along which the mobile device is capable of falling due to carelessness, and the falling proof device being made wider and thicker than the mobile device to prevent falling of the mobile device when the mobile device is used to communicate with the interrogating device; and
a lock mechanism in response to at least one of interaction between the key hole and the access keys and communication between the interrogating device and the mobile device for unlocking the smart lock structure and gaining the access.

9. The smart lock structure as claimed in claim 8, wherein the falling proof device is shaped as a selective one of a flat edge, a fillister with slopped and a curved wall.

10. A method for operating a smart lock structure to gain access to a secured area from a mobile device, comprising:
the smart lock structure receiving a request to unlock from the mobile device when the mobile device is within an effective transmission range of an interrogating device of the smart lock structure using radio frequency technology;
the interrogating device of the smart lock structure responding a seed value;
the mobile device sending back encrypted key information corresponding to the seed value;
the interrogating device decrypting and verifying the key information of the mobile device according to a first preset database of the smart lock structure; and
if matched, the interrogating device sending an unlocking command to the smart lock structure to unlock and gain the access to the secured area.

11. The method as claimed in claim 10, wherein the seed value comprises at least one of identification information of the mobile device, identification information of the smart lock structure, and a synchronized time preset between the mobile device and the interrogating device.

12. The method as claimed in claim 10, wherein in the step of the mobile device sending back encrypted key information, the mobile device permutes the data sequence of the key information.

13. The method as claimed in claim 12, wherein in the step of the mobile device sending back encrypted key information, the mobile device permutes the data sequence of the key information in a predefined sequence based on time information retrieved out of the seed value.

14. The method as claimed in claim 12, wherein in the step of the mobile device sending back encrypted key information, pseudo random data is added into the key information before the mobile device permutes the data sequence of the key information.

15. The method as claimed in claim 10, further comprising configuration of the smart lock structure before the step of the smart lock structure receiving a request to unlock from the mobile device, comprising:
at least one configuring device selected from the mobile device and other configuration computers requesting configuration of the smart lock structure to modify a permit list in the first preset database of the smart lock structure;
the smart lock structure verifying access of the at least one configuring device to the first preset database;
the at least one configuring device modifying the permit list of the smart lock structure; and
the smart lock structure saving modification of the permit list in the first preset database for authentication to unlock the smart lock structure.

16. The method as claimed in claim 15, wherein the modification to the permit list comprises creating at least one of an account and keys in user names, mobile phone numbers, passwords, series numbers of the mobile device, MAC numbers of the mobile device, ICCID of the mobile device, IMEI of SIM cards, and valid periods of authorization for any access.

17. The method as claimed in claim 16, wherein when an account is created, the smart lock structure automatically generates a corresponding cryptographic key according to one of symmetric-key cryptography and asymmetric-key cryptography to be saved in both of the mobile device and the smart lock structure for encrypting and decrypting use of the mobile device and the smart lock structure.

18. The method as claimed in claim 15, further comprising a step of the at least one configuring device encrypting and uploading the key information generated based on the modification of the permit list to a remote server, and the server generating an internet link to a prospective user by the Internet or Short Message Service (SMS) to provide the user with the key information after being granted by the server.

19. The method as claimed in claim 10, further comprising a step of the mobile device providing an access-denying message if the identification information of the smart lock structure is not found in a second preset database of the mobile device before the sending-back step of the mobile device.

20. The method as claimed in claim 10, further comprising a step of the interrogating device counting failure times of the verified key information being unmatched in the first preset database, and checking if the counted failure times are more than a threshold value during a preset period of time.
